(19) United States
(12) Patent Application Publication
(10) Pub. No.: US 2012/0215359 A1
(43) Pub. Date: Aug. 23, 2012

(54) ADAPTIVE FAN CONTROL BASED ON SERVER CONFIGURATION

(76) Inventors: Amir Meir Michael, San Mateo, CA (US); Ali Heydari, Berkeley, CA (US); Hu Li, Fremont, CA (US)

(21) Appl. No.: 13/031,318

(22) Filed: Feb. 21, 2011

(51) Int. Cl. G05D 23/19

(52) U.S. Cl. 700/275

(57) ABSTRACT

A server or other computing system contains a plurality of heat-generating electrical components and one or more cooling fans to dissipate heat from those components during operation. The fans are controlled by one or more fan controllers, which are programmed with an adaptive control algorithm to change the speed of each system cooling fan based on the needs of the components. The adaptive control algorithm is selected based on a detected configuration of the system's components, which may be detected upon startup of the system. During operation, a fan controller receives the component temperatures from one or more sensor and uses the algorithm to determine the fan speed. Thus, the system variably controls the speed of the fans based on the configuration of components housed in the server unit and on the current temperature of the components.

### BACKGROUND

This invention relates generally to servers and more particularly to operating fans to cool servers comprising one or more heat-producing electrical components.

Computer systems such as servers generate heat from the operation of electrical components such as processors and hard drives arranged therein. A constant temperature range, or rated temperature, is generally defined for each device or component, where operation within the rated temperature permits satisfactory operation of the component. Thus, it is desirable for servers and other computing systems to operate at a temperature that is acceptable for each of the components of the system. The temperatures at or near different components within the same server are often different, so the lack of a single temperature within the server complicates the need to keep each component within the temperature for which it is rated.

Conventionally, servers are individually equipped with a cooling system to dissipate heat produced during operation and thereby maintain the temperature at various locations in the server within a desired range as required by the server's components. Commonly, each server includes one or more fans to dissipate heat generated by the server's electrical components during operation. To control the operation of each cooling fan, a server uses one or more temperature sensors to determine temperatures within the server. The server sets the rotation of the fan at a higher or lower rate based on whether the measured temperatures are higher or lower than the rated temperatures for the components in the server.

However, the configuration of the components in a server or other computing system may be changed, thereby changing the cooling needs of the system. As a result, cooling systems are often set at a cooling target that is greater than necessary for the current configuration of the system. Thus, cooling fan systems may consume more energy and perform more cooling than necessary. Even worse, the configuration of the system could be changed so that the cooling needs of the individual components are greater than that for which the cooling system is set. This could lead to overheating of particular components in the system, reduced performance, and even system failure.

### SUMMARY

Embodiments of the invention adapt the cooling of a computing system based on its cooling needs, which may change based on the configuration of the components within the system. In one embodiment, the computing system is a server wherein system cooling fans are used to dissipate heat from the server. The speed of system cooling fans of a server is adjusted based on a configuration of the server, wherein the configuration may include the number, type, and placement of components and cooling fans in the server. On start-up, an inventory of components housed in the server unit is generated, where the inventory identifies the identity and location of each component. An algorithm to control the one or more system cooling fans is selected based on the configuration of the components, wherein the algorithm outputs a fan operation speed based on an input temperature. The algorithm is provided to a fan controller, e.g., by programming the fan controller accordingly. The fan controller then modulates the speed of each cooling fan based on an input temperature provided by one or more sensors measuring the local temperature of each component within the server unit.

In one embodiment, the algorithm to control a system cooling fan describes a relationship between the temperature of one or more of a plurality of components and the range of fan speeds required at various temperatures. The fan speeds may be expressed in terms of a pulse-width modulated (PWM) signal (i.e., a duty cycle for the fan). For example, a fan speed required to cool a component to a particular temperature can vary based on heat profile of the component and the configuration of the components including the distance between the component and fan. A temperature sensor can provide a local component temperature, wherein the local temperature can be input into the algorithm to determine a fan speed rate to keep the component's temperature below a threshold. Thus, a fan controller can modulate each cooling fan's speed to ensure each component's local temperature is below a threshold temperature based on the type of components, the configuration of components in the server unit, the distance between each fan and a component and the local temperature of each component.

### BRIEF DESCRIPTION OF THE DRAWINGS

FIG. 1 illustrates a system for controlling system fans to cool electrical components housed in a computing system in accordance with an embodiment of the invention.

FIG. 2 illustrates components of an adaptive fan control system, in accordance with one embodiment of the invention.

FIG. 3 illustrates a process for controlling system fans to cool electrical components housed in a computing system

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Configuration

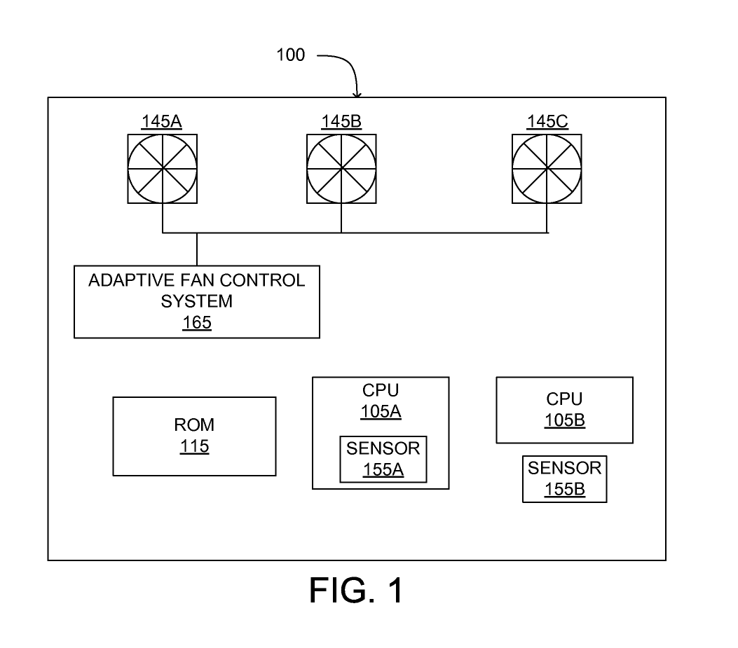

FIG. 1 illustrates electric components within a computing system 100 in accordance with an embodiment of the invention. In one embodiment, the computing system 100 is a server which includes one or more central processing units (CPUs) 105A, 105B, a ROM chip 115, one or more cooling fans 145A, 145B, 145C, one or more sensors 155A, 155B and an adaptive fan control system 165. The components shown in FIG. 1 are examples, and in other embodiments the computing system 100 includes additional and/or different components arranged in different configurations.

The electrical components, including CPUs 105 and RAM 125 generate heat during operation. Each electrical component may have a predefined constant temperature range for optimal or acceptable operation. The cooling fans 145 are therefore included in the server to remove excess heat from the components to enable them to run properly.

The cooling fans 145 are configured to operate at a variable speed. The adaptive fan control system 165 is coupled to each fan and constructed and arranged to control the speed of the fan. In one embodiment, the cooling fans 145 are driven by pulse-width modulation (PWM) technique, wherein a high duty cycle corresponds to a faster rotation of the cooling fan blades. The cooling fans 145 operate to provide cooling to one or more components such as CPUs 105 housed in the server unit 100 by removing exhaust air and drawing cool air from ambient air space of an equipment room. The rate of heat dissipation or cooling caused by the operation of the cooling fans depends on the rate or speed of operation of the cooling fan blades. Thus, the adaptive fan control system 165 can control the rate of heat dissipation associated with a component by modulating the cooling fan's PWM percentage.

Sensors 155 included in the server 100 monitor the temperature of one or more components within the server 100 and communicate the temperature to the adaptive fan control system 165. The sensor 155 may be integrated with a component, such as a CPU that measures temperature and has an output signal indicating the measured temperature. In another embodiment, the sensor 155 may be a separate chip or a component housed within the server. The adaptive fan control system can vary the speed of one or more fans 155 to remove heat from one or more components based on the temperature information received from the sensors. In one embodiment, the sensors 155 measure electric current drawn by each component in the server at a given time to determine the thermal output of each component. In other embodiments, the sensors 155 monitor air flow or air pressure near a component to determine its operating temperature.

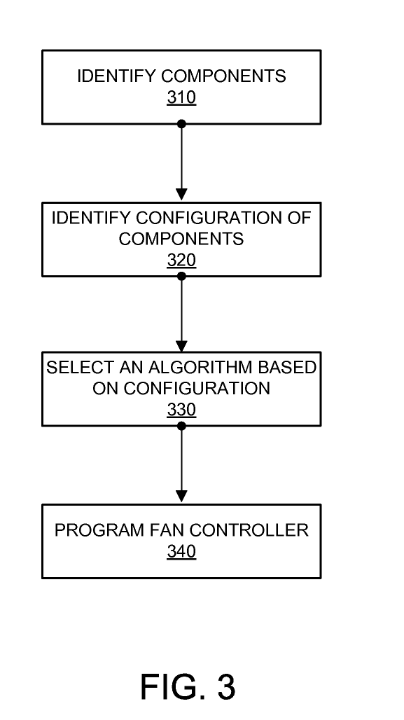

The ROM chip 115 is a storage media chip that stores the server's basic input/output system (BIOS) software. At startup, the BIOS stored on the ROM chip 115 initializes and identifies electrical components including the CPUs 110, the hard drives 130, cooling fans 150, etc. In one embodiment, the BIOS takes an inventory of all the components housed in the server unit 100 along with their location and stores the information locally on the storage unit 135. The BIOS then selects an appropriate cooling algorithm and programs the fan control system 165 with the algorithm at system start-up. The algorithm selection process performed by the BIOS is is described in greater detail below in reference to FIG. 3.

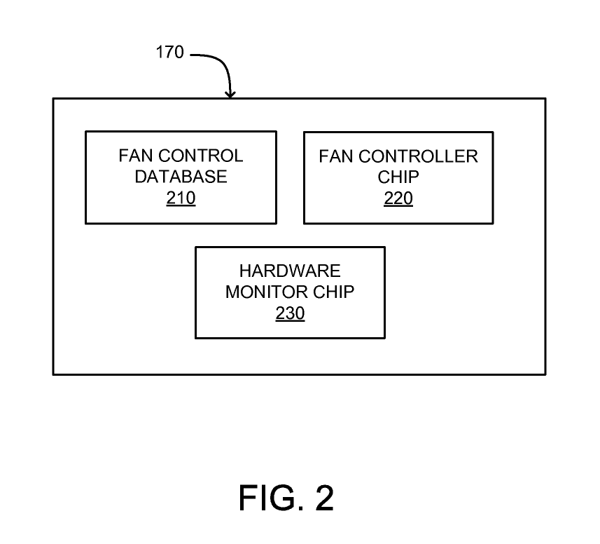

The adaptive fan control system 165 controls the operation of the cooling fans 145 based on the cooling algorithm selected by the BIOS and based on the measured temperatures. The adaptive fan control system 165 is illustrated in FIG. 2, according to one embodiment of the invention. Referring now to FIG. 2, the adaptive fan control system 165 includes a fan control database 210, a fan controller chip 220 and a hardware monitor chip 230.

The fan control database 210 includes any information that can be used by the fan control system to determine how to drive the cooling fans based on the operating conditions of the system. In one embodiment, the fan control database 210 includes an algorithm that provides a PWM percentage range for each fan in the computing system based on a temperature provided by sensors 155 at one or more locations in the computing system. In another embodiment, the fan control database 210 includes a table of PWM duty cycle % values for driving each fan within a configuration of components in a computing system. In such an embodiment, each fan is driven at the % duty cycle indicated by the table based on an operating conditions measured near one or more server components and the distance between the fan and an electric component. Thus, a cooling fan directed over a component may be driven faster than a fan further away or pointed away from the component. In another embodiment, each fan is driven based on the needs of a component with the highest cooling needs. For example, a fan can be driven at a highest PWM duty cycle percentage indicated by the set of tables for a given fan, thereby ensuring that a sufficient level of cooling is achieved for the component with the highest cooling needs.

In one embodiment, the PWM algorithm or table provide a PWM duty cycle percentage for a fan based on a temperature maintenance scheme. One example of a temperature maintenance scheme is a cruise threshold, wherein the fan control system is designed to maintain a component's temperature below a predefined threshold. In such a temperature maintenance scheme, the database of values includes a PWM percentage range for a fan at different temperatures. For example, the PWM percentage range value is higher when an input temperature provided by the sensor 155 is higher, allowing a fan dissipate heat at a faster rate when the component's operating temperature is higher. Other temperature maintenance schemes known in the art can be used in different embodiments allowing the adaptive fan control system 165 to maintain a component's operating temperature between several different operating ranges based on usage statics, etc. Thus, fan control database 210 can include several databases of values describing PWM percentage ranges for each fan at each temperature for each temperature maintenance scheme.

The PWM percentage range at each temperature for a temperature maintenance scheme may vary not only based on the type of component but also based on the location of components housed in the server unit 100. For example, a server that has two CPUs 105A and 105B housed close to each other within the server may require a different operation of a cooling fan 145 to maintain a temperature at different temperature ranges than a server that has only one CPU 105A. Thus, in one embodiment, the fan control database 210 includes several databases of values describing PWM percentage ranges for a cooling fan 145 and each component for each possible configuration of components in the server. Different configurations of components can include one or more combinations of CPUs 110, hard drives 130, and other electrical components, and their position relative to each other and the server unit 100. The possible configurations of components that can be included in the server can be limited based on data ports available to the server and/or physical limitations of the server unit 100.

The PWM percentage range at each temperature for a temperature maintenance scheme may also vary based on the location of a fan relative to a component in a configuration. For example, a cooling fan 145 located closer to a component may have a higher influence on the heat dissipated from the component than a cooling fan 145 located farther away from the component. Thus, a cooling fan that is closer to the electrical component has a different PWM percentage range to cool the component at different temperatures than the PWM percentage range required from a cooling fan that is further away. In one embodiment, the fan control database 210 includes several databases of values describing PWM percentage ranges for each fan for each component for each configuration.

In one embodiment, the fan control database 210 also includes a database of values describing the location of the server in a rack of a data center. As described in greater detail in reference to FIG. 3, a server in a rack can have an identifier such that the BIOS can determine the server's location within a rack. The PWM percentage range for operation of cooling fans 145 can vary based on the location of the server in the rack because of factors such as air flow, external temperature gradients across a server rack, and other operating conditions in a data center. Thus, the fan control database 210 may also include a database of values for PWM percentage ranges for varying temperatures based on the location of the server 105 at varying locations within a server rack.

The hardware monitor chip 230 receives data from the one more sensors 155 in the server unit 100. In one embodiment, the hardware monitor chip 230 converts raw data received from the sensors 155 to temperature data corresponding to values used in the look-up tables of the fan control database 210 to allow the fan controller chip 220 to control the operation of cooling fans 145 responsive to the operating temperature of each component.

The fan controller chip 220 controls the operation of each one or more cooling fans 145 housed within a server unit 100 based on the temperature provided by the hardware monitor chip 230. As described in greater detail in the specification, in one embodiment, the fan controller chip 220 is programmed by the BIOS, wherein the control program provides PWM percentage values for each cooling fan 145 based on the components and the configuration of components in the server unit 100.

FIG. 3 illustrates a process 300 for controlling cooling fans in a server based on the components and the configuration of components housed in a server unit 100. The process 300 starts as part of a startup sequence of the server 100. The process 300 identifies 310 electrical components housed in the server unit. In one embodiment, on startup, the system BIOS stored on the server ROM chip 115 performs a sweep of the server unit 100 to identify an inventory of components housed within the server 100. The BIOS may identify each component connected to the server by querying each component that is electrically connected to the server and identifying a unique identification value (ID value) for each component. The BIOS may perform a lookup operation in a database matching the identification values to identify each component.

In addition to the inventory of components, the BIOS identifies 320 the configuration of components stored in the server unit 100. For example, the BIOS may identify a port ID of each communication port connected to a component. In one embodiment, the ROM chip 115 includes a database of locations of each communications port based on its port ID. The BIOS can perform a lookup operation to determine the location of each port ID and identify 320 the configuration of components within the server unit 100 based on the location of each component. Thus, the BIOS may identify a distance between, for example, a cooling fan 145A and a CPU 105A based on their unique ID values and the ID values of their connection ports. In one embodiment, the BIOS 115 stores the identity and location of the components in a local table within the storage unit 135.

As described in reference to FIG. 2, the fan control database 210 stores algorithms or databases of values providing a PWM percentage range for operating a fan at varying component temperatures according to a temperature maintenance scheme. In one embodiment, the BIOS selects 330 an algorithm for each fan to cool an identified 310 component based on the identified 320 configuration of components and a temperature maintenance scheme. Thus, the algorithm can provide a PWM percentage range for a fan 145 to cool a component based on constants such as the identity of a component, the configuration of components, the temperature maintenance scheme, the location of the server 100 in a rack and variables such as the component temperature detected by the sensor 155. In one embodiment, the constants for the algorithm can be obtained by performing a lookup operation in the fan control database 210 and identifying PWM percentage values for each identified component, identified configuration of components, provided temperature maintenance scheme and an identified location of the server 100 in a rack.

In one embodiment, the process 300 programs the fan controller chip 220 based on the selected 330 algorithm. As described above, the fan controller chip 220 controls the operating speed of one or more cooling fans 145 by using the PWM technique. The program allows the fan controller chip 220 to control the cooling fan based on the component temperature received from the hardware monitor chip 230 and the configuration of components housed within the server unit 100. In addition, the BIOS can program the fan controller chip 220 to follow additional rules. For example, wherein two components require a cooling fan to operate at two different PWM percentages, the cooling fan 145 is operated at the highest PWM percentage required by either of the two components. In one embodiment, the fan controller chip 220 controls the cooling fan 145 based on the programming provided by the BIOS.

As an exemplary advantage according to the invention, the present invention provides a system and a method for efficiently running electrical components, whereby the components are cooled according to a function of the component's local temperature, the configuration of components within the server unit, the location of the server with an a rack. Such a method allows the cooling fans to run based on the local requirements of components thereby minimizing the load of the fans and thereby reducing power consumption and noise involved in the rotation of the system cooling fan.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for cooling electrical components in a computing system, the method comprising:
detecting a configuration of a plurality of electrical components installed in the computing system, the computing system including one or more cooling fans arranged to dissipate heat from the electrical components;
selecting a fan control algorithm for the system cooling fans in the computing system based on the identified configuration of electrical components to provide a rated level of cooling for the detected electrical components; and
programming one or more fan controllers in the computing system based on the selected fan control algorithm, wherein the fan controllers are coupled to control operation of the cooling fans based on the programmed fan control algorithm.

2. The method of claim 1, wherein the plurality of electrical components include one or more of a processor and one or more hard drives.

3. The method of claim 1, wherein identifying the configuration of the electrical components comprises identifying the location of the electrical components relative to the cooling fans.

4. The method of claim 1, further comprising:
selecting a fan control algorithm responsive to a temperature maintenance scheme providing a preferred rate of cooling required to reach a rated temperature range for each electrical component.

5. The method of claim 1, further comprising:
measuring a temperature of the plurality of electrical components;
operating the cooling fans at an operational speed provided by the one or more fan controllers responsive to the measured temperature of the electric components.

6. The method of claim 1, wherein the temperature of the plurality of electrical components is measured by one or more of temperature sensors and air pressure sensors.

7. The method of claim 1, wherein programming the one or more fan controllers comprises providing one or more tables including a fan speed for each one or more cooling fans based to the detected configuration of the electrical components and the measured temperature associated with each electrical component.

8. The method of claim 1, wherein the operational speed of the system cooling fan is variable responsive to a change in the server component temperature.

9. A computer program product for cooling electrical components in a computing system, the computer program product comprising a computer-readable storage medium containing computer program code for:
detecting a configuration of a plurality of electrical components installed in the computing system, the computing system including one or more cooling fans arranged to dissipate heat from the electrical components;
selecting a fan control algorithm for the system cooling fans in the computing system based on the identified configuration of electrical components to provide a rated level of cooling for the detected electrical components; and
programming one or more fan controllers in the computing system based on the selected fan control algorithm, wherein the fan controllers are coupled to control operation of the cooling fans based on the programmed fan control algorithm.

10. The computer program product of claim 9, wherein the plurality of electrical components include one or more of a processor and one or more hard drives.

11. The computer program product of claim 9, wherein identifying the configuration of the electrical components comprises identifying the location of the electrical components relative to the cooling fans.

12. The computer program product of claim 9, further comprising:
a computer-readable storage medium containing computer program code for selecting a fan control algorithm responsive to a temperature maintenance scheme providing a preferred rate of cooling required to reach a rated temperature range for each electrical component.

13. The computer program product of claim 9, further comprising:
a computer-readable storage medium containing computer program code for operating the cooling fans at an operational speed provided by the one or more fan controllers responsive to the measured temperature of the electric components.

14. The computer program product of claim 9, wherein programming the one or more fan controllers comprises providing one or more tables including a fan speed for each one or more cooling fans based to the detected configuration of the electrical components and the measured temperature associated with each electrical component.
